(19) United States
(12) Patent Application Publication
(10) Pub. No.: US 2006/0203894 A1
(43) Pub. Date: Sep. 14, 2006

(54) Method and device for impulse response measurement

(75) Inventor: Mika Ventola, Oulu (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/091,576

(22) Filed: Mar. 10, 2005

(51) Int. Cl. H04B 1/707; H04L 1/02

(52) U.S. Cl. 375/148; 375/150; 375/347

(57) ABSTRACT

The invention discloses a method, a receiver and a wireless terminal for measuring an impulse response e.g. in a (W)CDMA terminal having at least two receiving antenna branches with diversity reception. In the method one antenna branch is selected, e.g. by choosing the antenna with a good signal to interference ratio. An impulse response is measured for the selected antenna branch (full IRM) with a searcher. The delays of the propagation paths of the radio channel are estimated by selecting the delay values, whose correlation value exceed a threshold value. The impulse response measurement for the other antenna branch is performed only on the selected delay values (reduced IRM) with the searcher. The finger allocation for the selected antenna branch can be done immediately after the full IRM and for the other antenna immediately after the reduced IRM. The finger allocation for all branches can alternatively take place after the reduced IRM, simultaneously. The invention may be implemented in at least one of a programmable device, dedicated hardware, programmable logic and any other processing device.

### FIELD OF THE INVENTION

The invention relates to the impulse response measurement (IRM) in a receiver using Code Division Multiple Access (CDMA) or Wideband Code Division Multiple Access (WCDMA) technology.

### BACKGROUND OF THE INVENTION

One common phenomenon in mobile or radio communication technology is the multipath propagation. In the multipath propagation a radio signal propagates from a transmitter through-different propagation paths until it reaches a receiver. The radio signal can reflect from different surfaces such as building walls and other objects of nature. Different propagation paths have different lengths, which means that the transmitted signal is received multiple times at different time instants in the receiver. The signal is also attenuated and its phase is rotated differently in different propagation paths. The transmitter in mobile communication may be a fixed base station and the receiver may be a mobile phone. This leads to the fact that the properties of the radio channel present between the base station and the mobile phone vary continuously. Therefore, the receiver must cope with the multipath propagation to prevent the weakening of the received signal quality.

Antenna diversity is a well known method to improve quality of a received signal. In antenna diversity reception all antennas of a diversity antenna array receive a signal transmitted by a communication system. If the antennas are placed far enough from each other in the array, the propagation paths from a transmitting antenna to the receiving antennas have slightly different lengths. Therefore, the received signal components of the transmitted signal have different amplitudes and phases. The changes in amplitudes and phases can be compensated in the combining. Compared to a case where only one of the antennas is used, the quality of the signal combined over the antennas has better quality, because the energy of the combined signal is collected from more than one detector. Combining over the antennas improves the quality of the received signal even in a severe multipath channel.

The Code Division Multiple Access (CDMA) is based on a spread spectrum technique. The principles of a CDMA system are described in the next paragraphs. It should be noted that for a person skilled in the art it is clear that Wideband Code Division Multiple Access (WCDMA) can be used as well instead of CDMA.

Spread spectrum technique means that a data signal on a traffic channel is spread to a considerably wider frequency band before the signal is transmitted. Spreading to the wider band is achieved by means of a spreading code. Typically, the spreading codes are chosen in such a way that they are orthogonal with respect to each other. Orthogonal spreading codes do not correlate with each other. Moreover, each traffic channel is spread by its own spreading code. By allocating each traffic channel its own spreading code, it is possible to distinguish the traffic channels even though the spread traffic channels are transmitted simultaneously on the same frequency band. The traffic channels typically contain information data or control data for users in the system. The user can have one or several spreading codes depending on the transmission capacity reserved for each user.

(W)CDMA receivers use correlators, which are synchronized with a desired signal. The desired signal is recognized by the spreading code. In a receiver the data signal is restored to the original band with the help of the spreading code. Assuming orthogonal spreading codes, signals with some other spreading code than the desired one, arriving at the receiver do not correlate in an ideal 1-tap channel but the signals maintain their wide band and they are therefore received as noise. In a multipath channel the orthogonality of the received spreading codes is slightly lost. The problem can be mitigated by using long scrambling codes. With the use of long scrambling codes the loss of orthogonality is less severe in the multipath environment. Another reason to use the long scrambling codes is the possibility to separate terminals (in uplink) and cells their sectors (in downlink).

Multipath propagation can be monitored by measuring an impulse response of the radio channel. The impulse response of the radio channel is achieved from the received wideband signal by means of the spreading code. The cross correlation value of the spreading code and the received wideband signal is calculated with a certain delay value. In (W)CDMA system the cross correlation values are complex values. An absolute value (i.e. amplitude) and squared absolute value (i.e. power) of the cross correlation value are proportional to the signal amplitude and power, correspondingly. For simplicity, a term correlation value is used from now on to refer to all of the following three terms: the cross correlation value, its amplitude and its power. Any of these three can be used in impulse response measurement and further in delay allocation. The impulse response of the channel comprises correlation values (components) that are calculated for a specific delay range. In the impulse response, the delays that coincide with strong multipath components have higher correlation values than the other delays. The highest correlation value refers to the strongest received signal component. If the multipath component does not exist, the correlation value corresponds to the noise and interference of the system. When the (W)CDMA system is considered, the interference consists of other cell interference, own cell interference from other users of the same cell and external interference from another systems.

The (W)CDMA receiver typically has at least one matched filter whose task is to measure the impulse response. The cross correlation values of the received data and a predetermined sequence, like spreading code of the pilot channel, are calculated on different delays in the matched filter. The searcher controls the delays of the matched filter. Another task of the searcher is to identify delays and correlation values of the paths of the radio channel from the components of the impulse response. The delays of the paths of the radio channel can be found by comparing the correlation values of the impulse response to a predetermined threshold. Delays whose correlation values are higher than the threshold are detected as delays of the paths of the radio channel whereas the other delays are discarded as noise and interference.

In a typical (W)CDMA rake receiver, channel estimation information is needed for combining the different paths of the received signal. Channel estimation means approximating the channel transfer function (or generally channel characteristics) for example with the help of a priori known transmission pattern. There are three main methods for channel estimation. The first method is the data aided channel estimation in which known pilot symbols are transmitted. The receiver receives the pilots propagated through the radio channel and along with the stored pilot information, the channel is estimated.

The second method for channel estimation is the decision directed channel estimation. At first a rough channel estimate is obtained which is used to make symbol decisions. The channel estimate is further improved by using the decisions as pilot symbols. This method therefore includes some inherent delay. Furthermore one drawback in this method is that any errors in symbol decisions affect the final channel estimate.

The third method for channel estimation is so called blind channel estimation. Blind estimation does not use any pilot symbols or symbol decisions but rather certain characteristics of the modulated signal. This method has a relatively long convergence time.

One characteristic of the (W)CDMA technique is that the multipath propagation can be exploited in the (W) CDMA signal reception. A conventional (W)CDMA receiver is e.g. a rake receiver, which consists of one or more correlators that are called fingers. Each finger acts as a separate receiver unit and can be directed to correlate with a signal component, which has propagated along a specific propagation path and therefore arrives at the receiver with its own specific delay value.

The task of the finger is to despread one received multipath propagated signal component of the radio channel in order to produce a decision variable. This is achieved by allocating the delay of the despreading unit according to the delay of the radio channel. The spreading code, on the other hand, corresponds the signal that is to be detected. The delays and the spreading codes of the fingers are directed by the finger allocation unit, which utilizes the impulse response measured by the matched filter.

The delays of the fingers can be fine-tuned by tracking. The tracking is a means to update the impulse response result with relatively light calculation process. Some error factors affect the impulse response measurement, which are due to timing estimate inaccuracy, frequency offsets between transmitter's and receiver's clocks or relative velocity between the mobile station and the base station. The cross correlation value of the received data and the spreading code is calculated at the current delay value, which gives a so-called in-time correlation value. Similar measurement is performed a small time period earlier and later than the current delay value, in order to calculate early and late correlation values, correspondingly. If the early or late correlation value is higher than the in-time correlation value, the allocated delay of the despreading unit is tuned accordingly.

In order to compensate the amplitude and phase error caused by the radio channel, signal of each finger is phase-rotated and scaled. This is done by weighting the decision variable by a combiner weight ŵ_{l,m}. The weighting can be performed in the despreader or in a combiner. A task of the combiner is to combine the decision variables of the fingers in order to produce one combined decision variable i.e. estimate of the received symbol. The combined decision variable can be expressed by:

$$\hat{d} = {\sum }_{m = 1}^{M} {\sum }_{l = 1}^{L} {\hat{d}}_{l , m} {\hat{w}}_{l , m}^{*} , \qquad ( 1 )$$

where \hat{d}_{l,m} is the decision variable, l is the finger index, L is the number of fingers, m is the antenna branch index (equal to the antenna index of a diversity antenna system), M is the number of antennas and (.)* refers to complex conjugate. When the combined decision variables have been produced, they are detected, for example, by so-called Viterbi decoder.

It should be noted that though the examples of rake receiver have been given by assuming same amount of allocated fingers in each antenna, it is obvious for a person skilled in the art that the number of allocated fingers in each antenna branch does not have to be the same.

A well-known combining method is so-called Maximal Ratio Combining (MRC). In case of MRC the combiner weights are the channel estimates. Another well known combining method is so-called Optimum Combining (OC) or, alternatively, Interference Rejection Combining (IRC). The aim of the IRC is to maximize the instantaneous Signal to Interference plus Noise Ratio (SINR). IRC requires knowledge of the channel and the covariance matrix of interference plus noise. The combiner weights of the IRC can be calculated by
ŵ=ĉₙₙ⁻¹ĥ, (2)
where ĉₙₙ is an estimate of the covariance matrix of interference plus noise, (.)⁻¹ denotes matrix inversion and ĥ is a column vector that contains the channel estimates. The covariance matrix estimation and matrix inversion are known to a person skilled in the art.

One important and useful quantity, which is needed in (W)CDMA receiver is signal-to-interference ratio (SIR).
The estimated SIR is achieved by taking a ratio:

$$SIR = \frac{\hat{S}}{\hat{I}} , \qquad ( 3 )$$

where Ŝ is the signal power estimate and Î is the interference power estimate. Estimation of signal power and interference power in a (W)CDMA system are known to a person skilled in the art.

At present a problem is to find delays of the radio channel for (W)CDMA terminal that comprises a receiver, which supports antenna diversity reception. The delays of propagation paths of the radio channel are found in a more efficient way compared to prior art. The delays of the propagation paths and the correlation values corresponding the delays are found by measuring the impulse response of the radio channel. The impulse response is measured in a correlator (i.e. a matched filter) by calculating the correlation values of the received data and the spreading code of the pilot channel. When the delays and correlation values are found out, they are transferred to the finger allocation unit. The finger allocation unit allocates the spreading codes and the delays of the radio channel for the fingers. The allocation is based on the correlation values found by the impulse response measurement and the delays that have the highest correlation values are allocated in rake. Between the impulse response measurements and allocations, the delays of the fingers are tuned by tracking. With the help of the impulse response measurement and allocation process the receiver is able to despread, combine and decode the transmitted data efficiently. The receiver can be e.g. a rake receiver, which utilizes MRC, IRC or both.

Publication WO 0118985 discloses a method of processing CDMA signal components. The system includes a rake receiver. An impulse response is measured with a matched filter. WO 0118985 discloses an improved method for processing the received signal by moving the matched filter in a time axis with the help of calculated weighting values. The antenna used in WO 0118985 is a single receiver antenna with no diversity reception option.

Publication GB 2286509 discloses a method for locating the peaks of an impulse response using a rake receiver with the CDMA technology. Its purpose is to present a simpler and faster way of processing the impulse response measurement results. Plenty of calculations are performed on a measured impulse response but also in GB 2286509 only one receiving antenna has been used.

Publication EP 396101 discloses a space diversity receiver, which includes a plurality of antennas for receiving Time Division Multiple Access (TDMA) burst signals. Preamble data is exploited in the receiver. In the receiver there is a demodulator for each antenna and an impulse response detector for each antenna. Analysis and finally equalizing is performed on the measured delay components in order to combat intersymbol interference due to multipath reception.

When the diversity antenna reception is discussed, the fourth prior art solution (EP 396101) has a searcher for each receiver (RX) antenna. Thus the number of searchers required equals with the number of RX antennas. The benefit of this prior art solution is that there is no delay between measurements of each antenna because the measurements can be executed simultaneously. The drawback is a high amount of searchers resulting in high computational complexity and leading to large power consumption and hardware size.

Another alternative is that one searcher is executed twice. U.S. Pat. No. 6,628,733 discloses a method and device for diversity receiving. The device includes two antennas, a wireless receiving unit, a matched filter, a searcher, delay profile memories for both antennas, a finger allocating unit and a combining unit for the fingers. The antennas are connected to the receiver configuration by an antenna switch. Only one searcher is used for delay profile determination. This means that the data of the first antenna and the data of the second antenna are processed consecutively in the same searcher block. The benefit of such a solution is that the same hardware can be used for the measurements of both antennas. A problem with the solution is that although the hardware size is not increased compared to the single antenna receiver, the power consumption is comparable to the number of RX antennas. Moreover, this prior art solution suffers also from long measurement time because the data of each antenna is processed consecutively and impulse responses of both antennas are stored to a memory before the comparison against the threshold is made and the delays and correlation results are delivered to a finger allocation unit. The total measurement time over all the antennas, according to U.S. Pat. No. 6,628,733 is at least as long as the measurement time of the impulse response of one antenna multiplied by the number of antennas.

Additionally, a user of a wireless terminal affects the average received power in each antenna. One common situation is when the user's hand is touching the antenna and thereby causing impedance mismatching between the antenna and the feeding circuit. The average received power can then be significantly lower than in the other antenna. Also SIR can be significantly different in each antenna. The SIR variation in the antennas causes the accuracy of the correlation values of the impulse response in the first antenna to be different compared to the second antenna. Therefore, another problem present in prior art solutions is that the quality of the correlation values of the impulse response measurements of antennas may be significantly different.

### SUMMARY OF THE INVENTION

The present invention discloses an efficient way of measuring an impulse response of a radio channel for a finger allocation unit in a mobile terminal. The mobile terminal has a diversity antenna array comprising at least two antenna branches, which are receiving data. In the method according to the invention, received data of one of the antenna branches is selected. The second step of the invention is to measure at least one impulse response from the selected data. The measured impulse response comprises correlation values of the received data and their delays. This impulse response measurement is referred as a full impulse response measurement (full IRM) and the measured impulse response is referred as a full impulse response (full IR).

The third step is to estimate delays of the radio channel. A threshold value is defined. The correlation values of the measured full impulse response are compared against the threshold value. Correlation values exceeding the threshold level are selected. The comparison against the threshold and the delay selection are done in a delay estimator unit of the searcher. The estimated delays and corresponding correlation values can be saved into a memory for subsequent use.

Because the full impulse response is measured from only one antenna branch at a time the information of the impulse response(s) of the other antenna branch(es) is (are) older than the recently measured impulse response. Therefore, another principle of the invention is that the correlation values of the other antenna branch(es) is (are) measured on the delay values that have been found by measuring the impulse response of the received data of the selected antenna branch (i.e. on the delay values that have been found by the full impulse response measurement). This (these) measurement(s) is (are) referred as reduced impulse response measurement(s) and the measured impulse response(s) is (are) referred as reduced impulse response(s).

The detected delays and the correlation values corresponding to the delays from the reduced IRM are saved into the memory as well. The data in the memory is used for the finger allocation process.

There are two alternative ways of allocating the fingers. The first way is that the finger allocation is made immediately after the correlation values are measured and the delays of the radio channel have been estimated from the full IRM and stored to the memory. Next, the finger allocation is done by utilizing the delay and correlation values found by the full IRM. After this, the reduced IRM is performed, and the estimated delays and the correlation values corresponding to the estimated delays are achieved for a chosen another branch, as explained before. Immediately thereafter, the finger allocation is done again. This time, however, the finger allocation is done by utilizing the delay and correlation values of the reduced impulse response measurement. Thus, fingers are allocated twice in a measurement round, first by utilizing the measurement results of the full impulse response and after that by utilizing the measurement result(s) of the reduced impulse response(s).

The second way of allocating fingers is to perform it only once in a measurement round after the results of both full and reduced IRM are available. Therefore, the fingers are allocated by utilizing the delays and the corresponding correlation values of all antenna branches.

In one embodiment of the invention, the number of measurements can be further reduced by performing the reduced impulse response measurement on the delays that have been found by the full impulse response measurement and which are not yet allocated in the receiver. Thus, the number of correlation value measurements in the other antennas can be reduced even more, and, if all delays that have been found by the full IR measurement are already allocated in the receiver, the reduced IR can be completely excluded.

In one embodiment of the invention, the received data from which the full impulse response is measured is selected based on at least one of the following: the signal to interference (SIR) ratio, the signal level estimate, the interference level estimate, the number of allocated fingers in the receiver or by selecting the antenna in turn which has not been selected lately. At least one of the signal level estimate, interference level estimate, the SIR and the number of allocated fingers, is measured for each antenna branch. In the preferred embodiment the selected antenna branch has the highest SIR or signal level estimate, the lowest interference level estimate or greatest number of allocated fingers of all the antenna branches. It is also possible to use a combination of the previously mentioned quantities.

The impulse response (either full or reduced) is measured by calculating cross-correlation of a common pilot spreading code and the received signal.

In one embodiment of the invention, several impulse responses are measured consecutively from the received data and the correlation values of the impulse responses are averaged in order to produce an averaged impulse response. It is possible to average both full and reduced impulse responses. The averaging of the impulse responses improves the quality of the impulse response and therefore reduces probability of erroneous decisions on the delay estimation.

In one embodiment of the invention, the correlation values of the impulse response of the selected antenna are sorted in descending (or, alternatively ascending) order before the delays are estimated. In one embodiment of the invention, the threshold is set for the correlation values of full and reduced IRM. The delays are estimated so that their correlation values exceed the threshold level. Also, average noise and interference level can be determined and the threshold is set higher than that level. The average noise and interference level can be calculated from the measured impulse response or by using a predetermined value that can be computed from the specifications of the system.

In one embodiment of the invention, the allocated delays are fine-tuned by a tracking procedure, between two consecutive IR measurements.

In one embodiment of the invention, the diversity antenna used in the method comprises two antenna branches.

The inventive idea includes the diversity antenna receiver, which implements the previously mentioned embodiments of the method according to the invention. The inventive idea also includes a mobile terminal, which comprises the diversity antenna receiver and which furthermore implements the previously mentioned embodiments of the method according to the invention.

In another embodiment of the invention, the impulse response measurements are implemented with only one searcher. The searcher acts in a master mode when it executes the full IRM. The same searcher can be switched into a slave mode and then it performs the reduced IRM for the other antenna branches.

In one embodiment of the invention, the receiver is a rake receiver.

In one embodiment of the invention the receiver uses maximal ratio combining (MRC). In another embodiment of the invention the receiver uses interference rejection combining (IRC).

In one embodiment of the invention, the receiver is configured to use one of the CDMA and WCDMA technology. The technical specifications for the third generation mobile system stand as the main information source for CDMA and WCDMA technology.

In one embodiment of the invention, at least one of the functional means configured to implement the method steps, is implemented in at least one of a programmable device, dedicated hardware, programmable logic and any other processing device. An Application Specific Integrated Circuit (ASIC) and Digital Signal Processing (DSP) unit are examples of these.

One advantage of the invention is that only one searcher can be used for impulse measurement. Let us assume the following example. The common pilot channel has a spreading factor of 256, the over sampling ratio is Nₛ, the IRM is done over 256 chips, there are L fingers in the Rake receiver and M receiving antennas forming the diversity antenna. According to the prior art solution (EP 396101), where both antennas have their own searcher, M*Nₛ*256 matched filter operations are required in order to detect the delays and the corresponding correlation values of all antennas. If one searcher is excluded in the example as in the present invention, the required operations diminish to Nₛ*256 matched filter operations per measurement. Moreover, if the reduced IRM is performed for the other antenna(s), L_{d}*(M−1) additional matched filter operations, where L_{d} is the number of delays found by the full IRM measurement, are needed. Typically, L_{d} <<Ns*256 and often smaller than L. Therefore, the total computational complexity of M*Nₛ*256+L_{d}*(M−1) operations is less complex in the present invention compared to the prior art implementation (EP 396101).

According to the prior art solution U.S. Pat. No. 6,628,733, the impulse responses of each antenna can be measured consecutively. Therefore, there is no need for additional hardware. One of the drawbacks of this prior art solution is that the power consumption is still the same as in the previously described prior art solution. Moreover, the method presented in U.S. Pat. No. 6,628,733 requires more memory, because the (full) impulse responses of both antennas are stored before comparing the values of the impulse responses against the threshold. The memory is read and the impulse responses are delivered to the finger allocation unit simultaneously. This causes an additional delay in finger allocation process that must be avoided. The inventive method avoids the drawback as the delays and correlation values of the full impulse response measurement can be delivered immediately to the finger allocation unit and the finger allocation can be done immediately after the measurement. When the reduced impulse response measurement has been done, another finger allocation can be performed. The additional delay caused by the reduced impulse response measurement is shorter than the delay that would be caused for the full IRM of the other antenna(s). Therefore, the total delay that is caused before fingers of all antennas are allocated is shorter than in case of U.S. Pat. No. 6,628,733.

Another benefit of calculating the correlation result only on the estimated delay values is in the computational complexity. As the number of delays of the propagation channel is typically lower than the total number of delays in the delay range the saving in the computational complexity is clear. For example, assuming the full IRM is performed over Nₛ*256 delays and the number of fingers (detected paths) is 4, the computational complexity ratio between full and reduced IRM is Nₛ*64. In the present invention, the computational complexity is practically the same as in the method implemented according to U.S. Pat. No. 6,628,733 and clearly less than in the method implemented according to EP 396101.

### BRIEF DESCRIPTION OF THE DRAWINGS

The accompanying drawings, which are included to provide a further understanding of the invention and constitute a part of this specification, illustrate the method and apparatus of one embodiment of the invention and together with the description help to explain the principles of the invention. In the drawings:

FIG. 1 illustrates a preferred embodiment of the method according to the invention in a flow chart, for measuring impulse responses for a finger allocation unit in a (W)CDMA terminal,

FIG. 2 illustrates one example of the UMTS network layout,

FIG. 3 illustrates the radio channel of FIG. 2 in more detail,

FIG. 4 illustrates a first time axis representation according to the invention, where the timings of the full and reduced IR measurements and the finger allocations are disclosed,

FIG. 5 illustrates a second time axis representation according to the invention, where the timings of the full and reduced IR measurements and finger allocations (executed simultaneously for all branches) are disclosed,

FIG. 6 illustrates a second embodiment of the method according to the invention in a flow chart, including a memory block,

FIG. 7 illustrates a third embodiment of the method according to the invention in a flow chart, including a tracker and a memory block,

FIG. 8 illustrates one embodiment of a mobile terminal according to the invention, in a simple form,

FIG. 9 illustrates one example of required functional blocks in a flow diagram for executing the method according to the invention,

FIG. 10a illustrates one example of an implemented searcher according to the invention,

FIG. 10b illustrates another example of an implemented searcher according to the invention,

FIG. 10c illustrates a third example of an implemented searcher according to the invention,

FIG. 11 illustrates one example of a finger in a rake receiver according to the invention,

FIG. 12a illustrates one example of a weight estimator unit using IRC according to the invention,

FIG. 12b illustrates one example of a channel estimator unit according to the invention,

FIG. 13 illustrates one example of a combiner unit according to the invention, and

FIG. 14 illustrates one example of a finger allocation unit according to the invention.

### DETAILED DESCRIPTION OF THE INVENTION

Reference will now be made in detail to the embodiments of the present invention, examples of which are illustrated in the accompanying drawings. The invention discloses a simple way to measure impulse responses of a radio channel in a receiver having a diversity antenna array. Especially, the purpose of the invention is to reduce the effects of the problems existing in prior art. The problems in the prior art solutions are greater computational complexity, which leads to the greater amount of hardware, power consumption and/or delays between measurements of each receive antenna. By measuring the impulse response cost-efficiently it is possible to fight effectively against the multipath propagation with a CDMA or WCDMA mobile terminal using e.g. a rake receiver.

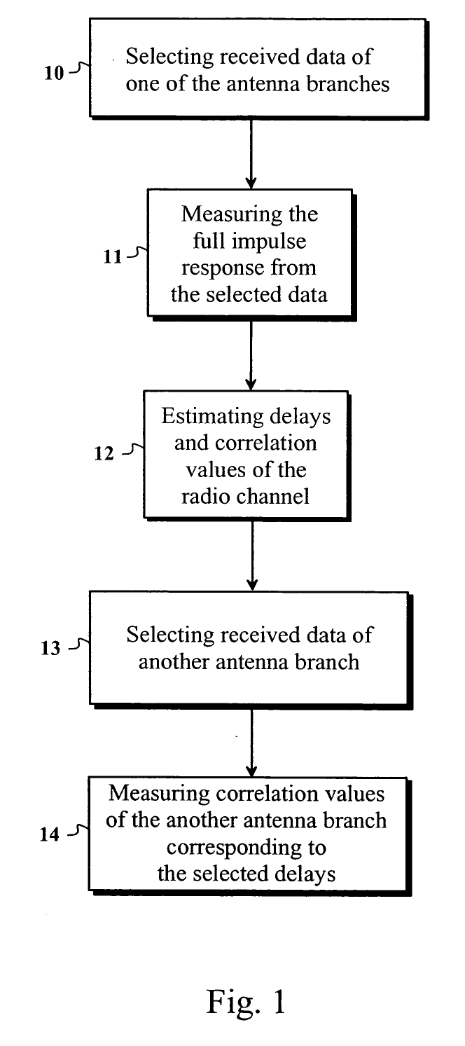

One embodiment of the method according to the invention is disclosed in FIG. 1. This embodiment discloses a straightforward finger allocation procedure for one antenna branch. The idea of the invention is to select the received data of one antenna branch 10, which belongs to the antenna array. This is referred as a first step. The examples of possible selection criteria are described later. When the antenna branch selection 10 is done, the impulse response measurement 11 is done for the selected received data. This measurement, which is applied to the selected received data of the antenna branch, is called full impulse response measurement (full IRM) 11. The impulse response is calculated by performing cross-correlation of a spreading code and the received signal over a predetermined delay range, as explained in prior art. The delays and the correlation values corresponding to them are also referred as the IRM result. The predetermined delay range can be, for example, one or more common pilot symbol(s) of a WCDMA system i.e. an integer multiple of 256 chips. The spreading code is preferably the spreading code of the common pilot channel. However the method is not limited to the usage common pilot but also any other pilot signal can be utilized. In this case, the number of delays within the delay range is Nₛ*256 samples, where Nₛ denotes oversampling. The correlation value is determined for a particular delay by calculating the complex correlation values of the received data and the spreading code on that delay. This is repeated for all Nₛ*256 delays in order to have full impulse response. Next, amplitudes of the complex correlation values are calculated according to prior art. When the spreading code is aligned with the delay of the propagation path, the amplitude that is greater than a noise and interference level of the system is seen. It should be noticed that also powers of the complex correlation values can be used instead of amplitudes. The measurement of the full impulse response 11 is referred as a second step.

The next step is to estimate delays of the radio channel from the full impulse response and the corresponding correlation values 12. This can be done by comparing the correlation values of the measured impulse response to a certain threshold value. In the preferred embodiment the threshold is set in such a way that it is higher than the average noise and interference level of the system so that the correlation values that correspond to noise and interference in the system would not exceed the threshold. When the threshold is set a little bit greater than the average noise and interference level it is possible to separate multipath components from distracting factors. Interference is here referred as any signal whose source is other than the transmitter of the useful signal. Typically interference is generated by the base stations of the neighboring cells or by another systems.

It is possible to define the threshold only once when the terminal's power is switched on and to use the defined threshold until the terminal is switched off. Another possibility is to adjust the threshold while the terminal is in use. The adjusting can be done, for example, by measuring the interference plus noise level of the impulse response and by adjusting the threshold accordingly.

When the appropriate threshold value is set, the system picks up the estimated discrete delay values 12 in which the threshold value is exceeded. The corresponding correlation values are also picked up. The delays of the paths whose amplitudes are greater than a threshold value are detected as delays of the propagation channel. Values whose correlation results are below the threshold level are regarded as noise and interference. This procedure 12 is referred as a third step.

In a preferable embodiment of the invention the maximum number of the delays that are estimated equals to the number of fingers in the Rake receiver.

The fourth step of this embodiment is selecting the received data of another antenna branch 13. If the diversity antenna comprises two branches, the branch, which has not been selected in step 10 is selected. If the diversity antenna comprises more than two branches, any branch, which has been skipped in step 10, can be chosen. In a preferable embodiment, such a branch, which has not been measured for a while is selected. This is to ensure that the data is as up-to-date as possible for the whole diversity antenna array when concerning plenty of consecutive measurement rounds.

In the fifth step 14 the reduced impulse response is measured for the antenna branch chosen in step 13. This means that the impulse response measurement from the received data of the other antenna branch 13 except the selected antenna branch 10, is performed on the estimated delay values 12 that have been found by the measurement 11 of the received data of the selected antenna branch. Preferably the reduced IR measurement is performed on the delays, which are not already allocated in the receiver.

The impulse response data is used in the finger allocation. The idea of the finger allocation is to check at first from the measured impulse response the delays are already allocated and the delays that are not allocated. Those delays, which are not currently allocated, are interpreted as new delays, which further on mean previously unnoticed propagation paths. The correlation value of the new delay is compared to the correlation values of the allocated delays. If the correlation value of the new delay is greater than the lowest correlation value of the existing allocated delays, the corresponding delay and correlation value are substituted by the new delay and its correlation value. The decision whether to allocate or not to allocate a new delay is performed in the same principle regardless of the way with which the measured delays and correlation values are achieved.

The finger allocation can be performed in two different basic ways when considering the flow chart in FIG. 1 and the timings of the different steps. These are explained later in more detail.

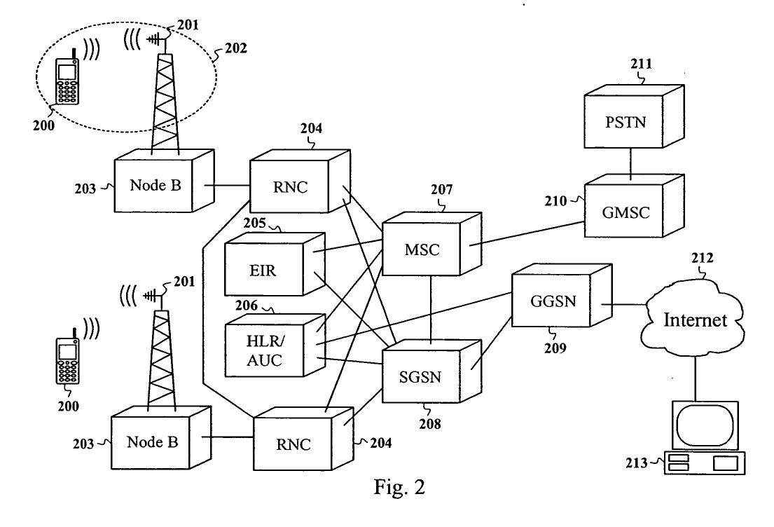

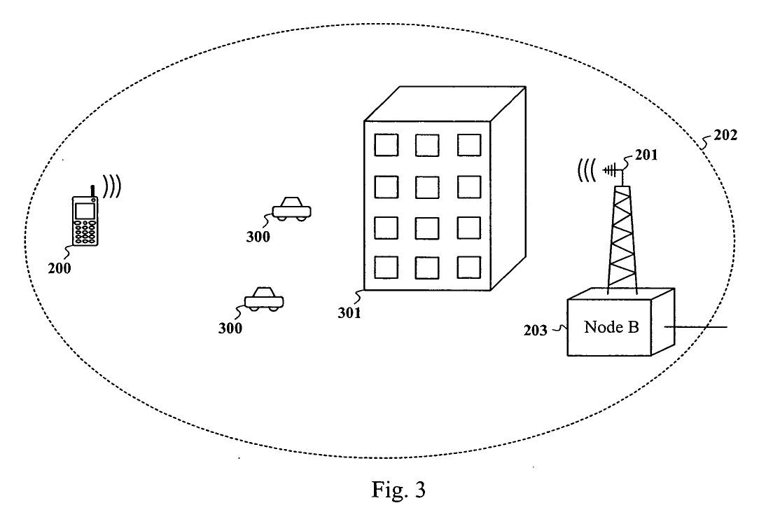

FIG. 2 shows an example of the UMTS system and its possible layout. In this example there are two UMTS base stations, which are disclosed in FIG. 2 as Node B 203. The base stations 203 have each an antenna 201. The Node B 203 converts the data in the interface between the radio channel 202 and Radio Network Controller (RNC) 204. The Node B 203 also takes part in radio resource management. A mobile terminal 200 is located within the cell area of the corresponding base station 203. The propagation environment between the mobile terminal 200 and the base station 203 is shown as a radio channel 202 within the dashed area. The radio channel 202 is shown in more detail in FIG. 3.

The node B 203 is connected to a RNC 204. The RNC 204 owns and controls the radio resources in its domain, in other words, the Node B:s connected to it. The RNC 204 is the service access point for all provided services, which includes, for example, connection management between the core network and the user equipment 200. The Radio Network Controllers 204 are furthermore connected to a Mobile Switching Center (MSC) 207. The Circuit Switched (CS) services are implemented in MSC 207. The Equipment Identity Register (EIR) 205 lists the validity of each user equipment 200, and gives access to the terminals, which are allowed to access the network. The Home Location Register (HLR) 206 is a database that stores the user's service profile. The Authentication Center (AuC) 206 handles the authentication requests generated by user terminals 200 accessing to the system.

The Serving GPRS Support Node (SGSN) 208 has the similar kind of functionality as the MSC 207. On the contrary, the SGSN 208 is typically used for Packed Switched services. The Gateway GPRS Support Node (GGSN) 209 is the switching point between the external packet data services and the UMTS network. One example of the Packed Switched network is the internet 212. External application servers 213 are thus available for the UMTS via the GGSN 209. The gateway to the Circuit Switched networks is the Gateway MSC (GMSC) 210 which is connected to the MSC 207. An external Public Switched Telephone Network (PSTN) 211 is thus available via the GMSC 210.

FIG. 3 discloses the radio channel 202 of FIG. 2 in more detail. The Node B 203 and its antenna 201 are in the other end of the radio link and the user's mobile terminal 200 is in another end. The radio channel 202 includes different kinds of scatterers. These scatterers can be physical barriers such as walls of buildings 301 or smaller particles such as cars 300. Thus, interference in the radio channel 202 can be caused by fixed or moving physical barriers.

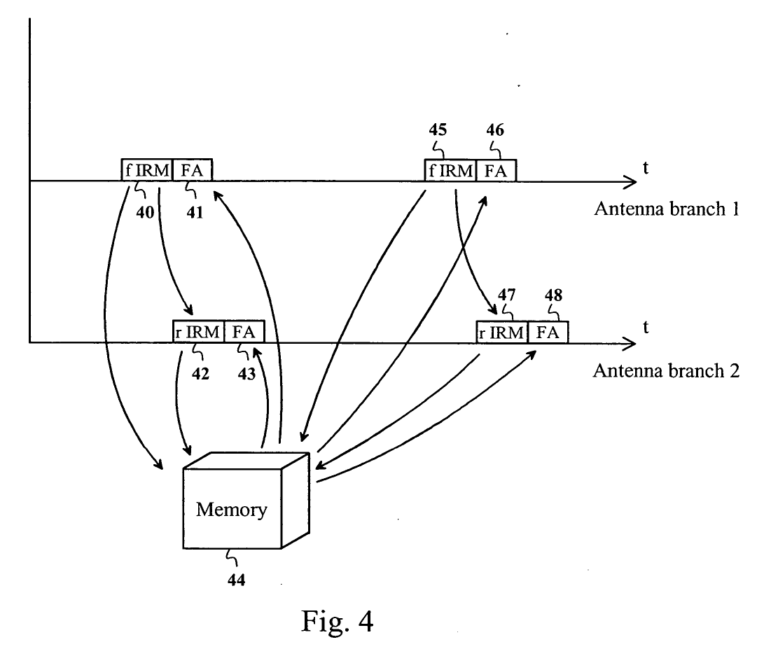

FIG. 4 presents one example of scheduling the events according to the present invention. Thus, it shows the timings of different measurements and finger allocations as a function of time. The antenna array has two branches in this example. This embodiment introduces the use of a memory, which gives the possibility of saving data and using the saved data later. FIG. 4 discloses an example of the present invention where the IRM data is up-to-date for both antenna branches, and where the procedure is represented as a function of time. The antenna branch is selected at first. The selected antenna is “Antenna branch 1” in FIG. 4. Full IRM is performed 40 for the received data of the selected antenna branch. The delay values are estimated, saved into the memory 44 and used for the finger allocation. In FIG. 4 the memory 44 is updated when the measurement is completed and the delays and correlation values are achieved. Therefore for instance, the full IRM result 40 is saved into the memory 44 and the data is fed to the finger allocation 41. The finger allocation 41 can be done immediately after the data 40 has been gathered. The reduced IRM 42 is performed on another antenna branch (“Antenna branch 2”) whenever the delay data from full IRM is available. Thus the reduced IRM 42 and the finger allocation 41 by utilizing the delays and correlation values found by the full IRM can be started simultaneously but there can also exist a delay between the starting times of the procedures 41, 42. The finger allocation for the other antenna branch 43 is performed when the delays and correlation values have been found from the data received by the other antenna 43.

Both the full IRM results and the reduced IRM results are saved into the memory 44. The finger allocation can be done so that the recently estimated delays and the correlation values corresponding to the delays, measured either by the full or reduced IRM, can replace allocated delays of any antenna. For example, it is not limited that a new delay found from antenna branch 1 can be used to replace an allocated delay of antenna branch 1 only, but the new delay can replace an allocated delay of any antenna branch.

When a desired time period has elapsed, it is possible to remeasure the full IRM 45 for the same antenna (branch 1) again as in step 40. When the full IRM is achieved, fingers will be allocated 46 immediately after the IR measurement, in this example. The delay data is transferred for another antenna (branch 2) where the reduced IRM is remeasured 47 as in step 42. The finger allocation 48 can take place for another antenna branch when the correlation values are achieved.

In one embodiment of the invention the reduced IRM procedure is modified in such a way that the reduced IRM is calculated on fewer delays values. When the full impulse response is measured from the first antenna branch, the estimation of delays is performed. The finger allocation for first antenna branch uses all found delays like stated earlier. The already allocated delays in the second antenna branch are checked. If there are any delays in the full IR, which are not already allocated in the second branch, they are considered as new delays. The reduced IRM is performed for the second branch only on these new estimated delays. This results in more efficient correlation value measurement in the reduced IRM procedure. In the extreme situation, the whole reduced IRM can be skipped. This happens for instance, when already allocated delays for both the first and the second branch and also the new estimated delays from full IRM, are exactly the same. In this kind of case new paths have not emerged, and thus the measurement round includes only the full IRM. For example, in the next measurement round the full IRM can be performed for the second branch instead of the first branch. With this kind of switching the antenna branch for the full IRM, it is possible to keep the memory data for all branches sufficiently new (in other words, the time between the IR measurement and the finger allocation using measured IR values is not too long).

The embodiment according to the previous paragraph can be clarified with the following example. Concerning the diversity antenna with two antenna branches, it is possible to select only the delays of the first branch, which are not already allocated in the second branch. For example, the first branch has allocated delays at delay values “0” and “5” while the second branch has allocated delays at delay values “0” and “10”. When the impulse response measurement is performed on the first branch, the result (delays exceeding the threshold) is “0”, “5”, “10” and “15”. The conclusion is that there has emerged two new propagation paths, which have not been allocated for the first antenna branch, that is “10” and “15”. When the second branch is examined, can be noticed that delays “5” and “15” are new paths for the second branch. After this, the reduced IRM is performed only on delays “5” and “15” for the second branch because “0” and “10” have already been allocated. This simplifies the reduced IRM procedure according to the invention even further. The finger allocation for the first antenna branch is performed by comparing the correlation values of delays “10” and “15” against the correlation values of all allocated fingers. Moreover, the finger allocation for the second antenna branch is performed by comparing the correlation values of delays “5” and “15” against the correlation values of all allocated fingers.

Furthermore, a second example on this issue is presented in the following. The first antenna branch is having allocated delays at values “0” and “5” while the second antenna branch has also the delays “0” and “5” allocated. Then the full impulse response is measured. The result gives the delays “0” and “5”, again. Therefore it can be assumed that there are not any new propagation paths. With the same principle as in the first example in the previous paragraph, the reduced impulse response measurement is not performed at all. The first measuring round is thus completed. The next measurement round can be started by selecting the second antenna branch first and measuring the full impulse response from the second antenna branch. This can be called as simple alternation of the antenna branches.

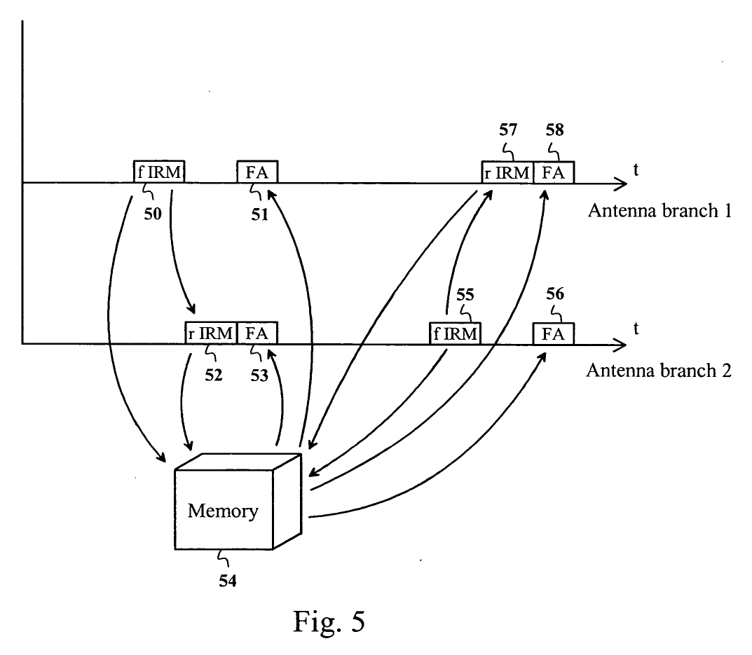

FIG. 5 discloses another embodiment of the present invention, with many similarities from FIG. 4, and with time axis representation. In this embodiment the finger allocation 51, 53 is performed simultaneously regardless of its input data being achieved from either full IRM 50 or reduced IRM 52. The IRM results can be saved into a memory 54. Additionally, the previously saved memory data 54 can be used later for a reduced IRM 52, 57 or for a finger allocation 51, 53, 56, 58. Another additional feature in FIG. 5 is that the selected antenna branch changes between two consecutive measurements. Therefore, the full IRM corresponds the action 50 and the finger allocation 56 corresponds the action 51. Respectively, 57 and 58 are performed similarly as 52 and 53.

One example of the time spans concerning FIGS. 4 and 5 is presented in the following. For example, in FIG. 4 the full IRM 40 is performed at the start of the first frame. The frame in the WCDMA is fifteen slots. In this embodiment the full IRM 40 is performed in the first slot of the frame and the rest fourteen slots the full IRM measurement process stays on an idle state. In the beginning of the next slot a reduced IRM is performed 42 for another antenna branch and simultaneously the finger allocation for the chosen antenna branch 41 is performed. The frame length is ten milliseconds (or 38400 chips) in the downlink. The next full IRM 45 is performed in this embodiment one frame later than the previous full IRM 40. Thus, the finger allocation is performed once in a frame in this example. The tracking is a possible procedure during the idle period (in other words; when IR measurement is in idle state). The present invention is naturally not limited to one explicit measurement or finger allocation frequency.

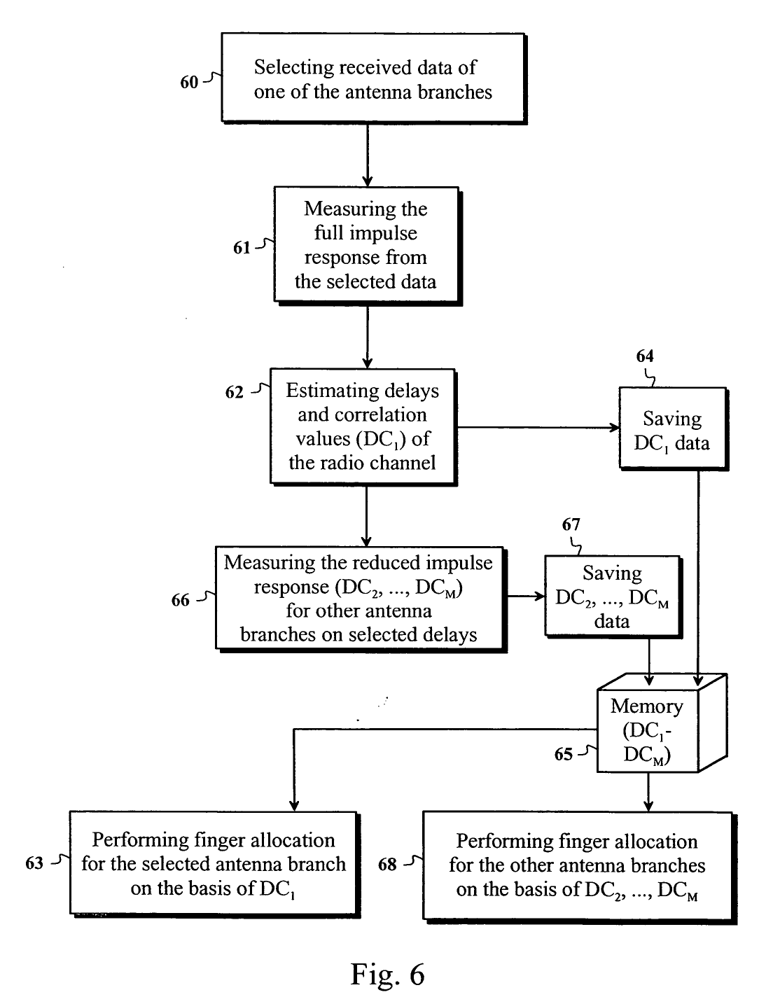

FIG. 6 presents a second preferred embodiment of the present invention. The first steps and the memory block 60-65 are the same as the steps 50-55 in FIG. 5. The received data in one antenna branch is selected 60. The full impulse response is measured from the selected data and the delay values are estimated from the impulse response 62. The delay values are estimated by comparing the correlation values against the threshold. The finger allocation is performed for the selected antenna branch on the basis of selected data DC₁ 63. The selected data DC₁ is saved 64 into memory 65. The reduced impulse response measurement 66 is performed for all the other antenna branches by calculating the correlation values are calculated on the delays that were found by the full impulse response measurement. The reduced IRM is done by calculating the correlation result of the received data of the other antenna branch and the spreading code on the estimated delay values.

The results from the reduced IRM are handled the same manner as the full IRM results. The data DC₂, . . . , DC_{M} is saved 67 into the memory 65 and thus the memory 65 is provided with the updated data for possible later use. The finger allocation is performed 68 for the antenna branches except the selected antenna branch 60. The finger allocation receives the new delay data from the memory.

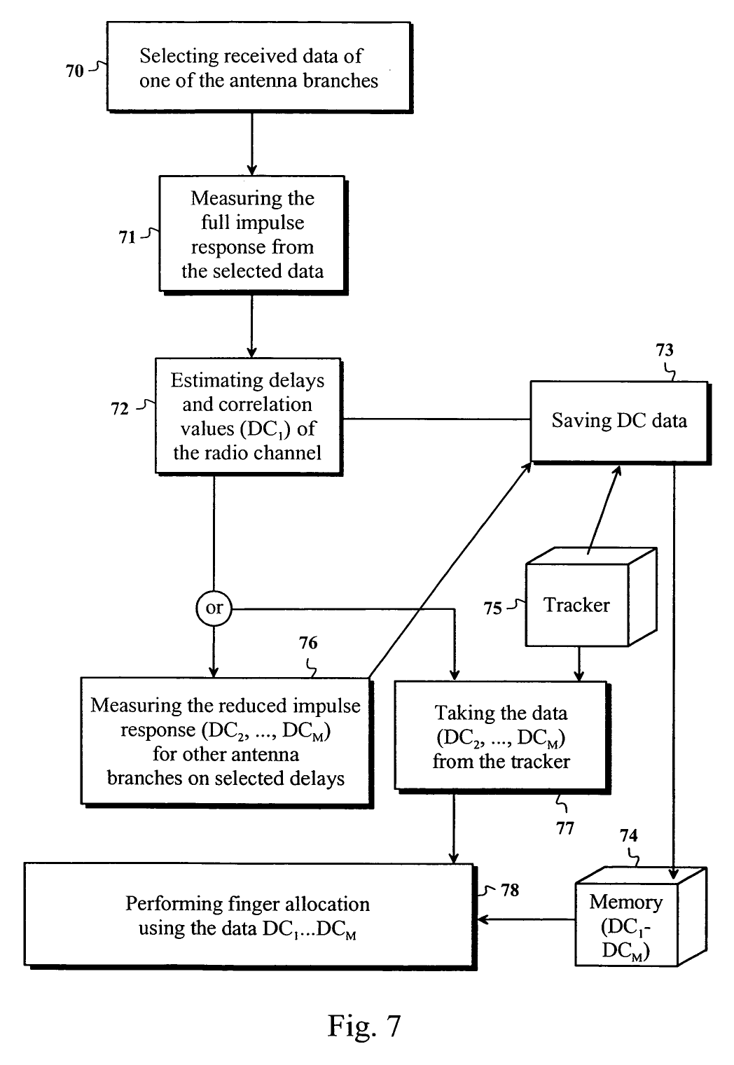

FIG. 7 presents a third preferred embodiment of the present invention. The steps 70, 71, 72, 73 and memory block 74 are similar to steps 60, 61, 62, 64 and memory block 65 of FIG. 6, correspondingly. The received data in one antenna branch is selected 70. The full impulse response is measured for the selected antenna branch 71 and the delay values are estimated from the impulse response 72. The delay values are estimated by comparing the correlation values against the threshold. The detected data DC₁ is saved 73 into memory 74. In this embodiment the delay and correlation value data of the other antenna branches is taken from the tracker 75, where the delay and correlation value information of the allocated fingers is available by means of on-time estimate. The tracker 75 measures the correlation values of delay values, which furthermore situate closeby to an allocated delay value. For example, three delays can be used in the tracking procedure, where one delay is a little bit smaller than the allocated delay and another delay is a little bit bigger than the allocated delay. The delay value with the highest correlation value is chosen. As the delays and the correlation values corresponding them are continuously tracked, the latest information is available. The delays from the tracker 75 are compared with the delays found by the full IRM. The reduced IRM is performed only for delays, which are not allocated at the present moment.

Should be noticed that the other antenna branch(es) utilizing the second and the third preferred embodiment are chosen among all antennas except the branch chosen in the step 60, 70.

According to yet another example of the invention, the diversity antenna includes four antenna branches. At first a full IRM is done on first antenna branch. The delays are estimated and the reduced IRM is done on second antenna branch. As explained before, finger allocation is done by taking into account the delays and the corresponding correlation values of the full and reduced impulse response measurements. On the next measurement round the third branch can be chosen for the full IR measurement. With the achieved delays, the fourth branch is the target for reduced IR measurement. Again, the finger allocation is executed as explained before. With such an alternation of antenna branches, the IR measurement data used for the finger allocation is not too old in order to achieve a reliable finger allocation for every branch.

In one embodiment of the invention, the received data from which the full impulse response is measured, is selected e.g. on a basis of the signal to interference (SIR) ratio, the signal level estimate, the interference level estimate, according to the number of allocated fingers in the receiver, or by selecting the antenna in turn which has not been selected lately. In the preferred embodiment the selected antenna has the highest SIR, the lowest interference level or greatest number of allocated fingers of all the antenna branches. It is also possible to use a combination of these. For example, the SIR and the number of allocated fingers or the interference level and the number of allocated fingers.

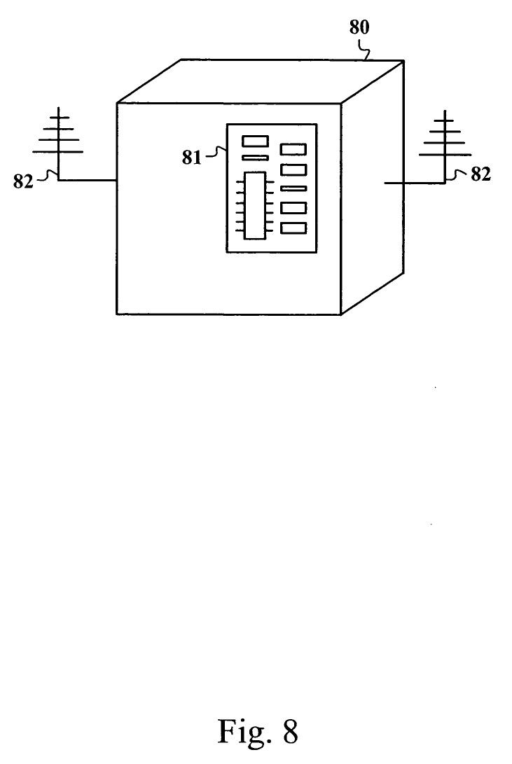

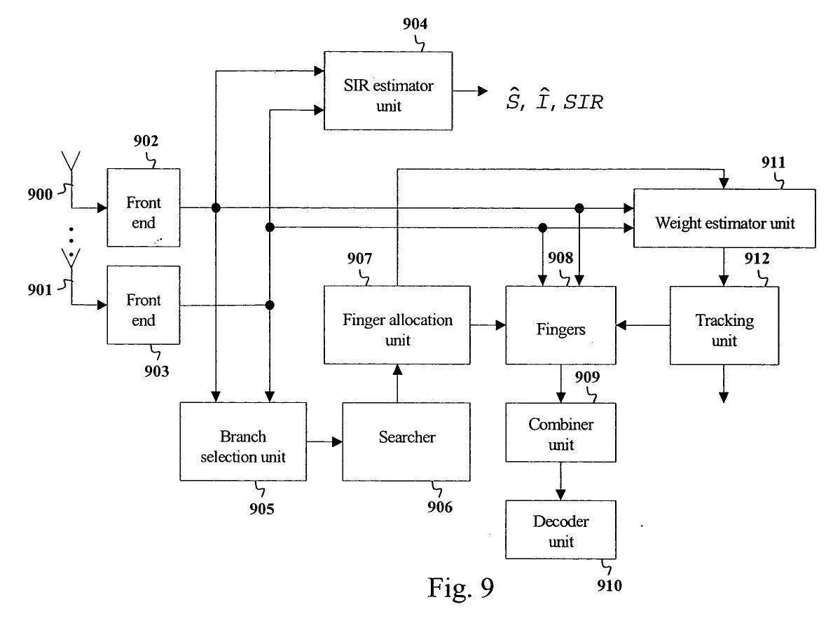

FIG. 8 presents one embodiment of a terminal in a simple form. The terminal 80 includes a circuit 81, which performs the functionalities of the invention. The terminal 80 has two antenna branches 82 in this example for making the diversity reception possible. More detailed figures showing the functionalities of the circuit 81 are disclosed in the following FIGS. 9-14.

Thus, examples of required functional blocks will be shown next. For simplicity, the examples assume two receiver antenna branches, as shown in FIG. 8. However, the invention is not limited to two receiver antenna branches, and thus more than two antenna branches can be used. One example of required functional blocks needed in the present invention is illustrated in FIG. 9. The diversity receiving antenna contains several antenna branches 900, 901. The antenna branches are connected to front ends 902, 903, which perform analog signal processing for the received signal such as amplifying filtering and analog-to-digital conversion. There are as many front ends 902, 903 in the receiver as there are antenna branches 900, 901 in the diversity antenna. As the first functional block of the present invention, the signal is fed to a SIR estimator unit 904. The signal to interference ratio is estimated for each received signal in the antenna branches 900, 901 according to the prior art. The estimated signal level, the estimated interference level or their ratio can be taken as output from the SIR estimator unit 904. The signal and interference levels as well as their ratio are used in the branch selection unit 905. The branch can be selected according to highest estimated SIR.

When the first antenna branch is selected, the searcher 906 performs the full impulse response. The searcher 906 estimates the delays and correlation values and sends them to the finger allocation unit 907. The actual fingers 908 of the rake receiver are directed by the finger allocation unit 907.

The fingers 908 perform despreading of the received data on the allocated delays in order to produce despread symbols of each finger. The despread symbols in each finger 908 are weighted by a weight coefficient that corresponds to the fingers. The weight coefficient is determined in a weight estimator unit 911. The weight estimator unit 911 is described more precisely later. The delay of each finger can be fine-tuned by a tracking unit 912. In addition, the number of fingers can be taken as output from the tracking unit block 912 and utilized in branch selection unit 905.

As a result of despreading and weighting, a decision variable is achieved for each finger 908. The decision variables are combined in a combiner unit 909 and therefore a combined decision variable is achieved. A combined decision variable is an estimate of a symbol that has been transmitted by a base station. After that, the decision variables are detected in a decoder unit 910.

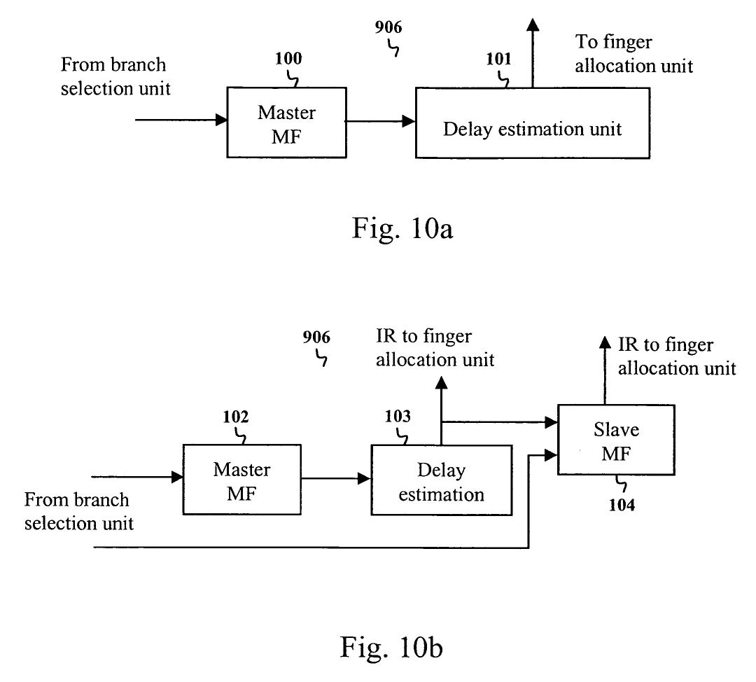

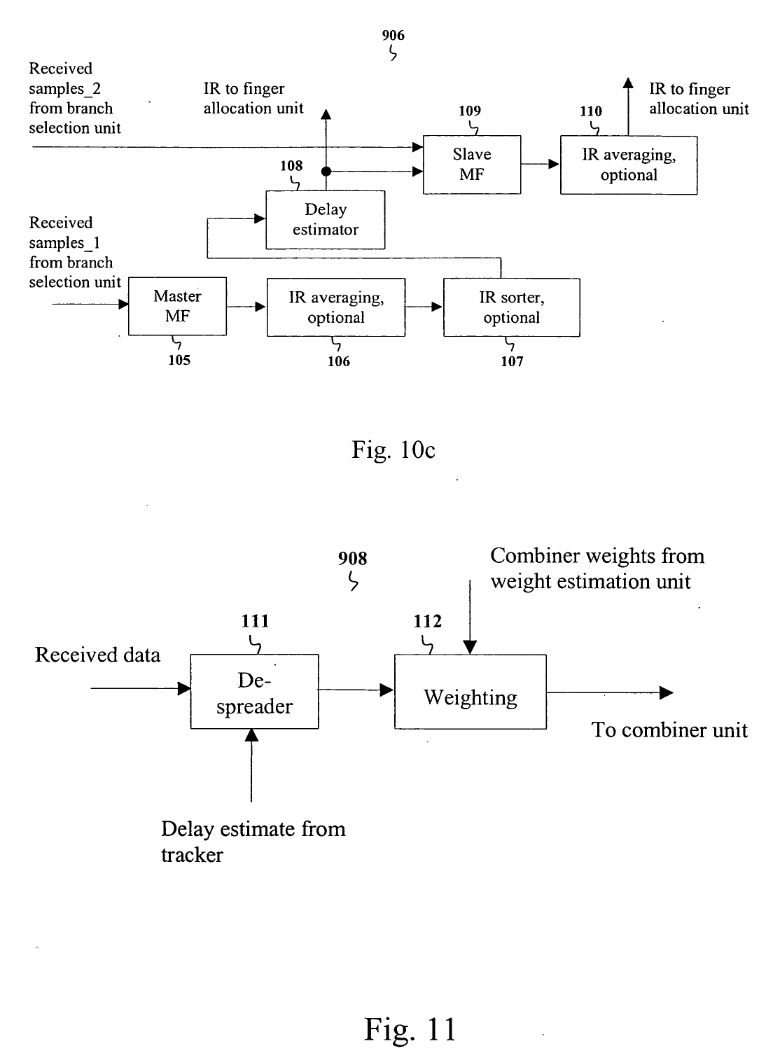

One embodiment of the searcher 906 is presented in more detail in FIG. 10a. The first block of the searcher 906 is a matched filter, which works as a master 100. The master matched filter performs the impulse response measurement over a desired delay range (full impulse response). The comparison against the threshold (i.e. estimation of the delays of the propagation channel) is done in a delay estimation unit 101. When the delays of the propagation channel have been detected the detected delays and the corresponding correlation values are delivered to the finger allocation unit 907.

A second possible embodiment of the searcher 906 is presented in FIG. 10b. In this embodiment the full impulse response is measured by a master matched filter 102. The estimation of the delays of the propagation channel is done in a delay estimation unit 103. The detected delays and the corresponding correlation values are delivered to the finger allocation unit 907. In addition, the detected delays are delivered to a slave matched filter 104. The reduced impulse response for the other antenna branch is measured by the slave matched filter 104, which will use the received signal of the other antenna branch as an input and can have the input, for example, from the branch selection unit 905. The reduced impulse response is measured by utilizing the received data of the other antenna branch, the estimated delays of the propagation channel and the spreading code. The resulting delay and correlation value data for the other antenna branch is directed to the finger allocation unit 907.

A third possible embodiment of the searcher 906 is illustrated in FIG. 10c. The full impulse response is measured for the received data of the selected antenna branch in master matched filter 105. In this embodiment it is possible to measure several full impulse responses and to average the results in IR averaging block 106. Additionally, it is possible to sort the resulting correlation value peaks in ascending or descending order. This is done in IR sorter block 107. The averaging and sorting blocks are optional. The comparison against the threshold is done in a delay estimator block 108.

The received data of the other antenna branch and the detected delay values from the delay estimator block 108 are directed into the slave matched filter 109, which calculates the reduced impulse response. Several reduced impulse responses can be measured and averaged in averaging block 110, which is optional. Once the averaged reduced impulse response has been produced, the delay and correlation value data from the second selected branch is directed to the finger allocation unit 907.

As an example in the averaging block 106, five impulse responses can be measured over five consecutive common pilot symbols. According to this example, in order to produce averaged correlation value of one particular delay, correlation values corresponding the delay are selected of the five impulse responses, summed together and the sum is divided by five. The procedure is repeated for every other delay of the impulse response. Furthermore, the correlation values of the averaged impulse response are compared against the threshold. The averaging of the impulse responses improves the quality of the impulse response and therefore reduces probability of erroneous decisions on the delay estimation.

The IR sorter 107 sorts the “delay, correlation value” pairs in ascending or descending order by their correlation values' magnitude. In one example/embodiment of the invention, the impulse response measurement (IRM) implementation is done over 256 delay values at the sampling ratio of Nₛ. This requires Nₛ*256 correlation values to be calculated in the matched filter. Moreover, in this example/embodiment of the invention the correlation values are sorted in descending (or, alternatively ascending) order before the delays before the comparison with the threshold level is performed. The sorting makes the delay estimation easier, because it is possible to pick L_{d} strongest correlation values (and the delay values corresponding to the correlation values) from the sequence When the correlation values are sorted in descending order, the highest correlation values can be found from the beginning of the sorted sequence. When the correlation values are sorted in ascending order the highest correlation values can be found from the end of the sorted sequence.

FIG. 11 illustrates an embodiment of one finger as a block diagram. The despreader 111 despreads one received multipath propagated signal component of the radio channel. The tracking unit 912 gives an estimate of the delay to the despreader 111. Furthermore, the despread data is weighted 112. The combiner weights are produced in weight estimator unit 911 and they are transferred to the weighting block 112. The output of the finger is a decision variable, which is directed to a combiner unit 909.

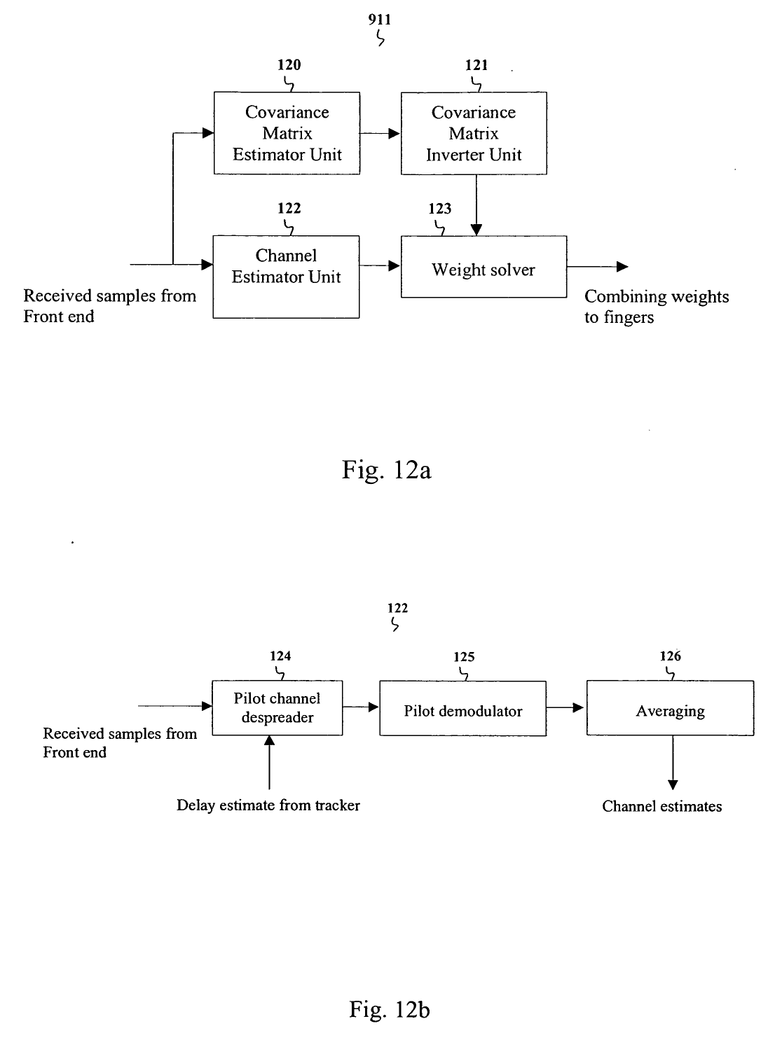

FIG. 12a illustrates one embodiment of a weight estimator unit using IRC (interference rejection combining). The received data from the front ends 902, 903 are transferred to a channel estimator unit 122. Channel estimates are needed for the weight coefficient solver 123 in order to calculate weights for each finger in the combiner 909. The received signal samples are also taken into a covariance matrix estimator unit 120 where the covariance matrix is calculated as explained in prior art. The covariance matrix is inverted in the covariance matrix inverter unit 121. The inverted matrix is used in the weight solver 123 as explained in prior art.

FIG. 12b illustrates one embodiment of a channel estimator unit. The received data are transferred from the front ends 902, 903 to the pilot channel despreader 120. The pilot channel despreader 120 needs the delay estimate from the tracker 912 and the pilot spreading code, similarly as the despreader 111 in FIG. 11. The despread pilot symbols are then demodulated in pilot demodulator by utilizing a priori knowledge of pilot symbols in order to produce channel estimates. The results are further averaged 126 in order to achieve the averaged channel estimates.

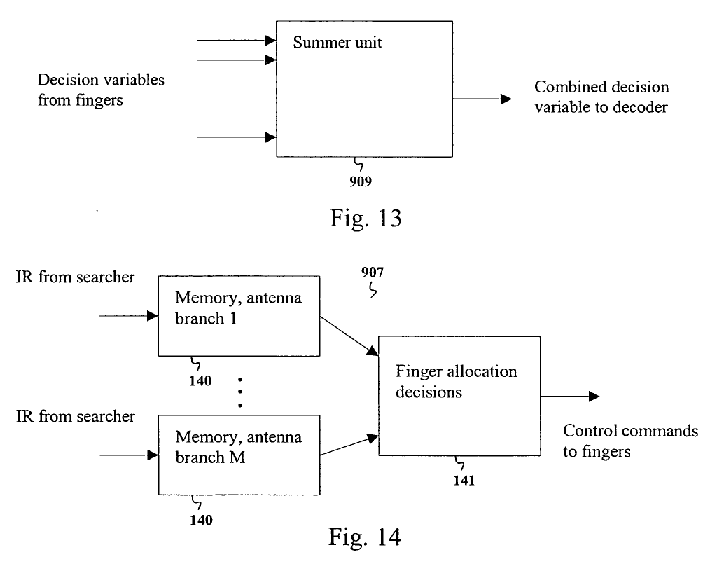

FIG. 13 shows an embodiment of the combiner unit 909. The combiner can be understood as a summing block, which takes the decision variables from fingers as input. The resulting output from the combiner unit is the combined decision variable, which is further delivered to a decoder unit 910.

FIG. 14 illustrates an embodiment of the finger allocation unit 907. The block contains several memory units 140, each for an antenna branch 1, . . . , M. The impulse responses, which have been measured, are been saved in the memory units 140. These memory units 140 are used as has already been explained in context of FIGS. 5-8. Decisions to allocate or not to allocate have been explained earlier in the text. The finger allocation decisions are made in a decision maker block 141, which uses the memory data 140. These decisions from 141 are fed to the fingers 908 as control commands.

In the preferred embodiment correlation values are delivered to a finger allocation block. The finger allocation block will make decisions on allocating and/or de-allocating of new/old rake fingers based on the correlation values. In the preferred embodiment, the impulse response measurement takes place once in a frame, but the measurements can also take place more often or seldom than once in a frame.

When the selection of the data from which the full impulse response measurement is done, it is possible to change the already selected antenna branch (which was used in the previous measurement). However, the selection of the data from which the full impulse response measurement is done, can be also made according to the signal and/or interference level of the antenna branches. The signal and interference levels of the antenna branches are measured by the SIR estimator unit. The signal and/or interference level of one antenna branch could be notably different when compared to the signal and/or interference of some other antenna branch of the receiver. In a preferred embodiment of the invention, the antenna branch selection is based on the highest SIR or the lowest interference level (I-estimate) of all the antenna branches. Moreover, it is possible to deliver the information of the number of allocated fingers in each antenna branch from the finger allocation unit and to select an antenna branch, which has the greatest number of allocated fingers of all the antenna branches. By utilizing the information of signal, interference and/or number of fingers, it is possible to improve the accuracy of the delay estimation and to assure that as many delays as possible are found. It is also possible to choose the antenna branch according to some combination of the previous data, like SIR and number of fingers of each antenna branch.

In one embodiment the number of searchers needed for the present invention is one. Then the same searcher works in both master and slave modes.

The techniques presented in prior art such as Maximal Ratio Combining (MRC) and Interference Rejection Combining (IRC) can be used with the present invention in order to receive transmitted data efficiently in the mobile terminal.

In one embodiment of the invention, at least one of the functional means configured to implement the method steps, is implemented in at least one of a programmable device, dedicated hardware, programmable logic and any other processing device. An Application Specific Integrated Circuit (ASIC) and Digital Signal Processing (DSP) unit are examples of these. For example, in one embodiment of the invention the chip level processing (for example matched filtering and despreading) is done on the ASIC and the symbol level calculations (for example thresholding, averaging and sorting) on the processing device.

It is obvious to a person skilled in the art that with the advancement of technology, the basic idea of the invention may be implemented in various ways. The invention and its embodiments are thus not limited to the examples described above, instead they may vary within the scope of the claims.

1. A method for measuring an impulse response of a radio channel for a finger allocation unit in a mobile terminal having a diversity antenna comprising at least two antenna branches, comprising:
receiving data on at least two antenna branches;
selecting data of one of the antenna branches;
measuring at least one impulse response from the selected data;
estimating delays of the radio channel from the impulse response and correlation values corresponding to the delays;
selecting data of another antenna branch; and
measuring correlation values corresponding to the estimated delays from the selected data of the another antenna branch.

2. The method according to claim 1, further comprising:
allocating fingers by utilizing the delays and correlation values of the selected antenna branch after selecting the data of one of the antenna branches; and
allocating fingers by utilizing the delays and correlation values of the another antenna branch after selecting the data of another antenna branch.

3. The method according to claim 1, further comprising:
allocating fingers by utilizing the delays and corresponding correlation values of all antenna branches after the measurement of correlation values of another antenna branch.

4. The method according to claim 1, further comprising:
comparing the estimated delays with current allocated delays after the impulse response measurement;
estimating the unallocated delays;
selecting data of the another antenna branch; and
measuring correlation values corresponding to the estimated unallocated delays from the selected data of the another antenna branch.

5. The method according to claim 1, wherein selecting the received data of one of the antenna branches based on at least one of a signal level estimate, an interference level estimate, a signal-to-interference ratio, a number of allocated fingers in the receiver or by changing the previously selected antenna.

6. The method according to claim 5, further comprising:
measuring at least one of the signal level estimate, the interference level estimate, the signal-to-interference ratio and the number of allocated fingers, of the received data in every antenna branch; and
selecting the received data of one of the antenna branches with the highest signal level estimate, the lowest interference level estimate, the highest signal-to-interference ratio or the largest number of allocated fingers.

7. The method according to claim 1, further comprising:
measuring the impulse response and correlation values by calculating cross-correlation of a common pilot spreading code and the received signal.

8. The method according to claim 1, further comprising:
measuring the impulse response at least twice consecutively; and
calculating an averaged impulse response before the estimation of delays.

9. The method according to claim 1, further comprising:
measuring the correlation values at least twice consecutively; and
calculating averaged correlation values on the estimated delay values.

10. The method according to claim 1, further comprising:
sorting the correlation values of the measured impulse response in ascending or descending order before the delays are estimated.

11. The method according to claim 1, further comprising:
setting a threshold for the correlation values; and
estimating the delays whose correlation values exceed the threshold.

12. The method according to claim 11, further comprising:
determining an average noise and interference level; and
setting the threshold higher than the average noise and interference level.

13. The method according to claim 11, further comprising:
calculating an average noise and interference level from the impulse response; and
setting the threshold higher than the average noise and interference level.

14. The method according to claim 1, wherein fine-tuning the estimated delays by measuring the correlation values of at least one delay value near the estimated delay and choosing the delay with highest correlation value, in a tracking procedure, between two consecutive impulse response measurements.

15. The method according to claim 1, wherein the diversity antenna comprises two antenna branches.

16. A diversity antenna receiver for measuring an impulse response of a radio channel for a finger allocation unit in a mobile terminal, comprising:
at least two antenna branches for receiving data and thus, forming the diversity antenna;
first selecting means for selecting data of one of the antenna branches;
first measuring means for measuring at least one impulse response from the selected data;
estimating means for estimating delays of the radio channel from the impulse response and correlation values corresponding to the delays;
second selecting means for selecting the data in another antenna branch; and
second measurement means for measuring correlation values corresponding to the estimated delays from the selected data of the another antenna branch.

17. The diversity antenna receiver according to claim 16, wherein:
the finger allocation unit is configured to allocate fingers by utilizing the delays and correlation values of the selected antenna branch after selecting the data of one of the antenna branches; and
the finger allocation unit is configured to allocate fingers by utilizing the delays and correlation values of the another antenna branch after selecting the data of another antenna branch.

18. The diversity antenna receiver according to claim 16, wherein:
the finger allocation unit is configured to allocate fingers by utilizing the delays and corresponding correlation values of all antenna branches after the measurement of correlation values of another antenna branch.

19. The diversity antenna receiver according to claim 16, further comprising:
the estimating means for comparing the estimated delays with current allocated delays after the impulse response measurement;
the estimating means for estimating the unallocated delays;
the second selecting means for selecting data of the another antenna branch; and
the second measurement means for measuring correlation values corresponding to the estimated unallocated delays from the selected data of the another antenna branch.

20. The diversity antenna receiver according to claim 16, wherein the first selecting means are configured to select the data of one of the antenna branches based on at least one of a signal level estimate, an interference level estimate, a signal-to-interference ratio, a number of allocated fingers in the receiver or by changing the previously selected antenna.

21. The diversity antenna receiver according to claim 20, further comprising:
third measuring means for measuring at least one of the signal level estimate, the interference level estimate, the signal-to-interference ratio and the number of allocated fingers, of the received data in every antenna branch; and
wherein the first selecting means are configured to select the received data of one of the antenna branches with the highest signal level estimate, the lowest interference level estimate, the highest signal-to-interference ratio or the largest number of allocated fingers.

22. The diversity antenna receiver according to claim 16, wherein the first and second measuring means for measuring the impulse response and correlation values, correspondingly, are configured to calculate cross-correlation of a common pilot spreading code and the received signal.

23. The diversity antenna receiver according to claim 16, wherein:
the first measuring means configured to measure the impulse response at least twice consecutively; and
wherein the receiver further comprises calculating means configured to calculate an averaged impulse response before the estimation of delays.

24. The diversity antenna receiver according to claim 16, wherein:
the second measuring means configured to measure the correlation values at least twice consecutively; and
wherein the receiver further comprises calculating means configured to calculate averaged correlation values on the estimated delay values.

25. The diversity antenna receiver according to claim 16, further comprising:
sorting means for sorting the correlation values of the measured impulse response in ascending or descending order before the delays are estimated.

26. The diversity antenna receiver according to claim 16, further comprising:
setting means configured to set a threshold for the correlation values; and
wherein the estimating means are configured to estimate the delays whose correlation values exceed the threshold.

27. The diversity antenna receiver according to claim 26, further comprising:
calculating means configured to determine an average noise and interference level; and
wherein the setting means are configured to set the threshold higher than the average noise and interference level.

28. The diversity antenna receiver according to claim 26, further comprising:
calculating means configured to calculate an average noise and interference level from the impulse response; and
wherein the setting means are configured to set the threshold higher than the average noise and interference level.

29. The diversity antenna receiver according to claim 16, further comprising:
a tracker configured to fine-tune the allocated delays by measuring the correlation values of at least one delay value near the estimated delay and choosing the delay with highest correlation value, between two consecutive impulse response measurements.

30. The diversity antenna receiver according to claim 16, wherein the diversity antenna comprises two antenna branches.

31. The diversity antenna receiver according to claim 16, further comprising:
a searcher configured to include both the first and second measuring means.

32. The diversity antenna receiver according to claim 16, wherein the diversity antenna receiver is a rake receiver.

33. The diversity antenna receiver according to claim 16, wherein the diversity antenna receiver is configured to use maximal ratio combining (MRC).

34. The diversity antenna receiver according to claim 16, wherein the diversity antenna receiver is configured to use interference rejection combining (IRC).

35. The diversity antenna receiver according to claim 16, wherein the diversity antenna receiver is configured to use one of the Code Division Multiple Access and Wideband Code Division Multiple Access technology.

36. The diversity antenna receiver according to claim 16, wherein at least one of the first and second selecting means, the first and second measuring means, the estimating means, the calculating means, the setting means, the finger allocation unit, the memory, the tracker and the searcher, is implemented in at, least one of a programmable device, dedicated hardware, programmable logic and any other processing device.

37. A mobile terminal for measuring an impulse response of a radio channel for a finger allocation unit, comprising:
at least two antenna branches for receiving data and thus, forming a diversity antenna;
first selecting means for selecting data of one of the antenna branches;
first measuring means for measuring at least one impulse response from the selected data;
estimating means for estimating delays of the radio channel from the impulse response and correlation values corresponding to the delays;
second selecting means for selecting the data in another antenna branch; and
second measurement means for measuring correlation values corresponding to the estimated delays from the selected data of the another antenna branch.

38. The mobile terminal according to claim 37, wherein:
the finger allocation unit is configured to allocate fingers by utilizing the delays and correlation values of the selected antenna branch after selecting the data of one of the antenna branches; and
the finger allocation unit is configured to allocate fingers by utilizing the delays and correlation values of the another antenna branch after selecting the data of another antenna branch.

39. The mobile terminal according to claim 37, wherein:
the finger allocation unit is configured to allocate fingers by utilizing the delays and corresponding correlation values of all antenna branches after the measurement of correlation values of another antenna branch.

40. The mobile terminal according to claim 37, further comprising:
the estimating means for comparing the estimated delays with current allocated delays after the impulse response measurement;
the estimating means for estimating the unallocated delays;
the second selecting means for selecting data of the another antenna branch; and
the second measurement means for measuring correlation values corresponding to the estimated unallocated delays from the selected data of the another antenna branch.

41. The mobile terminal according to claim 37, wherein the first selecting means are configured to select the data of one of the antenna branches based on at least one of a signal level estimate, an interference level estimate, a signal-to-interference ratio, a number of allocated fingers in the receiver or by changing the previously selected antenna.

42. The mobile terminal according to claim 41, further comprising:
third measuring means for measuring at least one of the signal level estimate, the interference level estimate, the signal-to-interference ratio and the number of allocated fingers, of the received data in every antenna branch; and
wherein the first selecting means are configured to select the received data of one of the antenna branches with the highest signal level estimate, the lowest interference level estimate, the highest signal-to-interference ratio or the largest number of allocated fingers.

43. The mobile terminal according to claim 37, wherein the first and second measuring means for measuring the impulse response and correlation values, correspondingly, are configured to calculate cross-correlation of a common pilot spreading code and the received signal.

44. The mobile terminal according to claim 37, wherein:
the first measuring means are configured to measure the impulse response at least twice consecutively; and
wherein the mobile terminal further comprises calculating means configured to calculate an averaged impulse response before the estimation of delays.

45. The mobile terminal according to claim 37, wherein:
the second measuring means are configured to measure the correlation values at least twice consecutively; and
wherein the mobile terminal further comprises calculating means configured to calculate averaged correlation values on the estimated delay values.

46. The mobile terminal according to claim 37, further comprising:
sorting means for sorting the correlation values of the measured impulse response in ascending or descending order before the delays are estimated.

47. The mobile terminal according to claim 37, further comprising:
setting means configured to set a threshold for the correlation values; and
wherein the estimating means are configured to estimate the delays whose correlation values exceed the threshold.

48. The mobile terminal according to claim 47, further comprising:
calculating means configured to determine an average noise and interference level; and
wherein the setting means are configured to set the threshold higher than the average noise and interference level.

49. The mobile terminal according to claim 47, further comprising:
calculating means configured to calculate an average noise and interference level from the impulse response; and
wherein the setting means are configured to set the threshold higher than the average noise and interference level.

50. The mobile terminal according to claim 37, further comprising:
a tracker configured to fine-tune the allocated delays by measuring the correlation values of at least one delay value near the estimated delay and choosing the delay with highest correlation value, between two consecutive impulse response measurements.

51. The mobile terminal according to claim 37, wherein the diversity antenna comprises two antenna branches.

52. The mobile terminal according to claim 37, further comprising:
a searcher configured to include both the first and second measuring means.

53. The mobile terminal according to claim 37, wherein the mobile terminal includes a rake receiver.

54. The mobile terminal according to claim 37, wherein the mobile terminal is configured to use maximal ratio combining (MRC).

55. The mobile terminal according to claim 37, wherein the mobile terminal is configured to use interference rejection combining (IRC).

56. The mobile terminal according to claim 37, wherein the mobile terminal is configured to use one of the Code Division Multiple Access and Wideband Code Division Multiple Access technology.

57. The mobile terminal according to claim 37, wherein at least one of the first and second selecting means, the first and second measuring means, the estimating means, the calculating means, the setting means, the finger allocation unit, the memory, the tracker and the searcher, is implemented in at least one of a programmable device, dedicated hardware, programmable logic and any other processing device.

58. A computer program embodied on a computer readable medium for measuring an impulse response of a radio channel for a finger allocation unit in a mobile terminal having a diversity antenna comprising at least two antenna branches, the computer program controlling a data-processing device to perform the steps of:
receiving data on at least two antenna branches;
selecting data of one of the antenna branches;
measuring at least one impulse response from the selected data;
estimating delays of the radio channel from the impulse response and correlation values corresponding to the delays;
selecting data of another antenna branch; and
measuring correlation values corresponding to the estimated delays from the selected data of the another antenna branch.
